(19) United States
(12) Patent Application Publication
(10) Pub. No.: US 2025/0094700 A1
(43) Pub. Date: Mar. 20, 2025

(54) SMALL SAMPLE FINE-TURNING METHOD AND SYSTEM AND RELATED APPARATUS

(71) Applicant: SUZHOU METABRAIN INTELLIGENT TECHNOLOGY CO., LTD., Suzhou, Jiangsu (CN)

(72) Inventors: Hongli LIU, Suzhou, Jiangsu (CN); Feng LI, Suzhou, Jiangsu (CN); Tong YU, Suzhou, Jiangsu (CN); Chong SHEN, Suzhou, Jiangsu (CN)

(21) Appl. No.: 18/724,632

(22) PCT Filed: Nov. 28, 2022
(86) PCT No.: PCT/CN2022/134801

§ 371 Date: Jun. 27, 2024

(30) Foreign Application Priority Data
Apr. 15, 2022 (CN) 202210392419.0

(51) Int. Cl. G06F 40/186

(52) U.S. Cl. CPC G06F 40/186

(57) ABSTRACT

The present application relates to the technical field of computers. Provided is a small sample fine-turning method, the method comprising: inputting a data set, and forming an input sample according to a fixed template; constructing a candidate tag word set and a candidate prompt template set; by means of reinforcement learning, searching an optimal tag word corresponding to the input sample from the candidate tag word set, and a prompt template corresponding to the input sample from the candidate prompt template set; and outputting a mapping relationship of the optimal tag word and an optimal prompt template format corresponding to the prompt template.

### CROSS-REFERENCE TO RELATED APPLICATION

The disclosure claims the priority of a Chinese patent application filed on Apr. 15, 2022 before the CNIPA, China National Intellectual Property Administration with the application number of 202210392419.0 and the title of “SMALL SAMPLE FINE-TURNING METHOD AND SYSTEM AND RELATED APPARATUS”, which is incorporated herein in its entirety by reference.

### FIELD

The disclosure relates to the field of computer technology and, more particularly, to a small sample fine-tuning method, system, and related apparatus.

### BACKGROUND

Currently, fine-tuning a pre-trained language model (LM) in downstream tasks has become a common practice in the NLP field. In the standard “pre-training and fine-tuning” paradigm, the gap between the pre-training phase and downstream tasks may be significant: they have different training objectives. For downstream tasks, it is often necessary to introduce new parameters. However, with the increasing size of the language models, it is difficult to fine-tune the pre-training model and new task-related parameters effectively with full parameters, but the prompt-based fine-tuning can make the downstream tasks adopt the same format as the pre-training target, and no new parameters are needed.

When the prompt template contains some training examples, the pre-trained language model can perform many tasks. However, this type of small sample learning can be very unstable: the selection of prompt template formats, training samples, and even the order of training samples may lead to a shift in accuracy from near-by-chance to near-state-of-the-art levels. This instability results from deviations of the language model to predict certain answers, for example, those placed near the end of a cue, or those commonly found in pre-training data, which tend to result in a change in the output distribution of the model. Therefore, different prompt templates have a large impact on the final accuracy.

To better accomplish related downstream tasks, most current prompt templates are designed based on human intuition. However, finding a suitable and correct prompt template requires both professional knowledge and a full understanding of the way in which the language model operates. In fact, manually designing prompt templates or tag words for different tasks is a laborious matter. Therefore, a prompt automated construction method should be used. However, the search space of the prompt template is large, and when only a small amount of labeled data is used for template search, it is easy to cause over-fitting.

### SUMMARY

It is an object of the disclosure to provide a small sample fine-tuning method, system, non-volatile readable storage medium, and electronic device, which can reduce the difference between different prompt templates and improve the accuracy of downstream tasks.

In order to solve the above-mentioned technical problem, the disclosure provides a small sample fine-tuning method, and the technical solution is as follows:
inputting a data set, and forming an input sample according to a fixed template;
constructing a candidate tag word set and a candidate prompt template set;
by means of reinforcement learning, search an optimal tag word corresponding to the input sample from the candidate tag word set, and a prompt template corresponding to the input sample from the candidate prompt template set; and
outputting a mapping relationship of the optimal tag word and an optimal prompt template format corresponding to the prompt template.

According to some embodiments, the step of inputting the data set, and forming the input sample according to the fixed template includes
acquiring input content;
representing the input content in the fixed template;
calculating a cosine similarity between the input content and all samples in a training set; and
random sampling from a preset percentage of training set samples to obtain the input sample.

According to some embodiments, the constructing the candidate tag word set and the candidate prompt template set includes:
automatically selecting the optimal candidate tag word; and
automatically selecting a candidate prompt template.

According to some embodiments, the automatically selecting the candidate tag word includes:
initializing a vocabulary;
vectorizing all the words in the vocabulary using a word2vec method, and determining a near-synonym set corresponding to each tag via the cosine similarity;
selecting, for each category in the training set, a word in the vocabulary that maximizes the conditional probability, and a conditional probability set comprising the word, by a pre-training model that is not fine-tuned:
determining a candidate tag word under each category as a maximum value of a geometric intersection of the near-synonym set and the conditional probability; and
integrating candidate tag words under various categories, and determining an assignment mode which maximizes the accuracy rate of the training set as the optimal candidate tag word.

According to some embodiments, the automatically selecting the candidate prompt template includes:
determining the optimal candidate tag word;
generating an initial prompt template by filling a placeholder; wherein the initial prompt template is configured to maximize an output probability in the training set; and
decoding the initial prompt template using a bundle search algorithm to obtain the candidate prompt template.

According to some embodiments, by means of reinforcement learning, searching the optimal tag word corresponding to the input sample from the candidate tag word set, and the prompt template corresponding to the input sample from the candidate prompt template set includes:
determining a preset number of candidate tag word set for each category;
combining the candidate tag word set with a template set corresponding to the candidate prompt template to obtain a search space list;
by means of the search space list, determining an optimal tag word corresponding to the input sample from the candidate tag word set, and a prompt template corresponding to the input sample from the candidate prompt template set.

The present application further discloses a small sample fine-tuning system, including:
a sample forming module configured to input a data set and form an input sample according to a fixed template;
a candidate set construction module configured to construct a candidate tag word set and a candidate prompt template set;
an optimum selecting module configured to search, by means of reinforcement learning, an optimal tag word corresponding to the input sample from the candidate tag word set, and a prompt template corresponding to the input sample from the candidate prompt template set; and
an output module configured to output a mapping relationship of the optimal tag word and an optimal prompt template format corresponding to the prompt template.

According to some embodiments, the sample forming module comprises:
an input unit configured to acquire input content;
a conversion unit configured to represent the input content in the fixed template;
a similarity calculation unit configured to calculate the cosine similarity between the input content and all samples in the training set; and
a sampling unit configured to randomly sample from a preset percentage of training set samples to obtain the input sample.

The present application further discloses a non-volatile readable storage medium having stored thereon a computer program that, when executed by a processor, implements the steps of the method above.

The present application further discloses an electronic device, comprising a memory having stored thereon a computer program, and a processor that implements the steps of the method above when calling the computer program in the memory.

The disclosure provides a small sample fine-tuning method, and the technical solution is as follows: inputting a data set, and forming an input sample according to a fixed template; constructing a candidate tag word set and a candidate prompt template set; constructing a candidate tag word set and a candidate prompt template set; and outputting a mapping relationship of the optimal tag word and an optimal prompt template format corresponding to the prompt template.

In the disclosure, by constructing a candidate tag word set and selecting an intersection of a near-synonym set and a conditional probability set, the candidate tag word search space is reduced, and at the same time, the difference between different prompt templates is reduced, improving the accuracy rate of a downstream task. The use of the prompt fine-tuning pre-training model reduces memory requirements and system complexity, especially to prevent small sample over-fitting. At the same time, the disclosure uses a reinforcement learning process to search for the optimal tag words and templates, so as to solve the problem that a general algorithm easily falls into a local optimum.

The disclosure also provides a small sample fine-tuning system, a non-volatile readable storage medium, and an electronic device having the above-mentioned advantageous effects, which will not be described in detail herein.

### BRIEF DESCRIPTION OF THE DRAWINGS

In order to more clearly illustrate the technical solutions of the embodiments of the disclosure or the prior art, a brief description will be given below of the embodiments or the accompanying drawings that are required to be used in the description of the prior art. It is obvious that the drawings in the description below are only some embodiments described in the disclosure, and it would be obvious for a person skilled in the art to obtain other drawings according to these drawings without involving any inventive effort.

FIG. 1 is a flowchart of a small sample fine-tuning method provided in an embodiment of the disclosure;

FIG. 2 is a structural schematic diagram of a small sample fine-tuning method provided in an embodiment of the disclosure; and

FIG. 3 is a structural schematic diagram of an electronic device provided in an embodiment of the disclosure.

### DETAILED DESCRIPTION

In order to make the purpose and technical solution advantages of the embodiments of the disclosure more clear, the following will provide a clear and complete description of the technical solution in combination with the accompanying drawings in the embodiments of the disclosure. Obviously, the described embodiments are a part of the embodiments of the application, not all of them. Based on the embodiments in the disclosure, all the other embodiments obtained by a person of ordinary skill in the art without manufacturing any inventive effort fall within the scope of protection of the disclosure.

The following is a description of the concepts related to the disclosure:

In general, the NLP (Natural Language Processing) efficient pre-training framework surrounds three parts: model pre-training, model fine-tuning, and model reasoning.

The current study of prompts has two different directions: firstly, for very large models like 175B GPT-3 and 11B T5, it is difficult and costly to fine-tune them, so it is desirable to fix their parameters and then apply different prompts to different tasks, but usually the accuracy of the method is not comparable to fine-tuning. secondly, using the prompt-based fine-tuning method, the quantity of optimization parameters can be greatly reduced while maintaining accuracy.

In a standard fine-tuning scheme, the input sentence is usually a [CLS] statement 1 [SEP] or a paired sentence [CLS] statement 1 [SEP] statement 2 [SEP], and then an additional classifier (full link layer+softmax (normalized exponential function)) is added to the [CLS] part. This approach may introduce new parameters and results in local optimum during training.

This can be effectively mitigated by using the prompt-based fine-tuning method, i.e. the downstream task can be regarded as an “auto-completion” task of the mask language model (MLM). For example, the input sentence is:

$${x}_{prompt} = [ CLS ] {x}_{1} It was [ MASK ] \cdot [ SEP ]$$

Where x₁ represents the input sentence, and then It was [MASK] represents a prompt template, wherein the [MASK] part is a tag word as a substitute for the tag of the class to which the current sentence belongs. For example, for a movie comment bi-classification task, it includes positive and negative, then, two words of great (good) and terrible (bad) can be used as tag words of the two classes, respectively.

It is worth noting that the above method reuses pre-trained parameter weights and does not introduce any new parameters for fine-tuning. It also reduces the gap between fine-tuning and pre-training, which can be used more efficiently for small sample scenes.

When acting as a classification task:

$$\begin{matrix}p ( y \vert {x}_{in} ) = p ( [ MASK ] = ℳ ( y ) \vert {x}_{prompt} ) \\ = \frac{exp ( {w}_{ℳ ( y )} \cdot {h}_{[ MASK ]} )}{{\sum }_{{y}^{′} ∈ y} exp ( {w}_{ℳ ( {y}^{′} )} \cdot {h}_{[ MASK ]} )}\end{matrix}$$

Originally, an input sentence xᵢₙ is given, which belongs to a probability corresponding to a certain class y. After the conversation, when giving an input sentence xₚᵣₒₘₚₜ, the [MASK] in its prompt template is predicted as the probability of a mapped tag word M(y).

From the above analysis, it can be seen that the prompt is composed of two parts:
template T: e.g., It was [MASK] and
tag word mapping M(y): namely, the prediction vocabulary set output at [MASK] position forms a mapping relationship with the real tag y.

In the prompt-based fine-tuning method, the selection of different templates and tag words actually has a great influence on the final result: using the same “tag word”, even minor changes to the “template” (such as changing punctuation marks) can present different results; using the same “template”, different “tag words” also have different effects.

Therefore, how to alleviate this instability and automatically construct an effective prompt template is the current research hotspot.

In the process of natural language processing, the scenes that need to find similar sentences or words are often encountered, involving the sentence or word similarity calculation. The calculation process includes: firstly, performing word segmentation on the sentence, acquiring a corresponding vector for each of the divided words, adding all the vectors and averaging to obtain a sentence vector, and finally calculating the cosine value of the included angle thereof using the following formula, wherein the closer the cosine value is to 1 (namely, the smaller the included angle is), the higher the similarity between sentences or words is;

$$cos ( θ ) = \frac{{\sum }_{i = 1}^{n} ( {x}_{i} {•y}_{i} )}{\sqrt{{\sum }_{i = 1}^{n} ( {x}_{i}^{2} )} \cdot \sqrt{{\sum }_{i = 1}^{n} ( {y}_{i}^{2} )}}$$

Using the word2vec model to calculate the vector is currently one of the commonly used methods. Word2vec, an NLP tool introduced by Google in 2013, is characterized by vectorizing all words so that the relationship between them can be quantitatively measured and the relationship between words can be mined.

Key factors in reinforcement learning include model agent, environment, state, action, and reward. The goal of reinforcement learning is to learn a policy such that the agent makes appropriate actions at appropriate times to obtain the maximum reward.

Two important it approaches in reinforcement learning are Q-value-based reinforcement learning and policy gradient-based reinforcement learning. The essence of the policy gradient algorithm is to build a policy network, predict what policy should be currently implemented by observing the state of the environment, implement this policy, and obtain the maximum reward that can be obtained.

Prompt fine-tuning introduces bias from the pre-training corpus. For example, in a zero sample sentiment classification setting, given “N/A” as an input, GPT-3 tends to predict “positive” rather than “negative”, and a 50/50 probability should be assigned to the two opposite tags. Another problem is that different representations of the same object (e.g. “computer” and “PC”) may compete for probabilistic quality, resulting in an undesirable distribution on task tags. Therefore, correction is necessary in practical applications.

The core idea of the disclosure is to compensate for the biased tag words and calibrate them to an unbiased state. The process includes: first inputting a textless sample, i.e., combining the textless words [“N/A”, “ ”, “[MASK]”] with the tag word, e.g., “N/A” and the tag word “good” are combined to form a Prompt: “N/A. This evaluation is very good”; then inputting Prompts into the language model, outputting the logits corresponding to the position of the tag word, averaging and normalizing to obtain p_cf; calculating the correction matrix according to the formula W=[diag(p_cf)]⁻¹ and the probability of the corrected category according to p_{cal}=softmax(W*pₚᵣₑ+b), where b is zero in the disclosure.

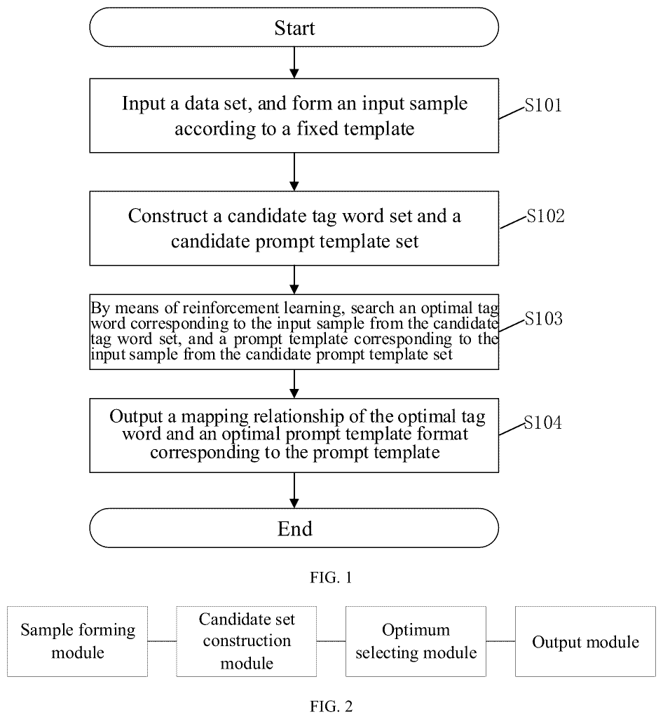

Please refer to FIG. 1, which is a flowchart of a small sample fine-tuning method provided in an embodiment of the disclosure, the method includes:
S101: inputting a data set, and forming an input sample according to a fixed template;
S102: constructing candidate tag word set and a candidate prompt template set;
S103: by means of reinforcement learning, search an optimal tag word corresponding to the input sample from the candidate tag word set, and a prompt template corresponding to the input sample from the candidate prompt template set; and
S104: outputting a mapping relationship of the optimal tag word and an optimal prompt template format corresponding to the prompt template.

First, the data set is input and subjected to data processing, including:
initializing a prompt template format, T: sentence, indicates that this evaluation is very _.
inputting downstream task data, which is divided into a training set, a verification set, and a test set;
encoding a sentence by SBERT (sentence-BERT, sentence-Bidirectional Encoder Representations from Transformer) method; calculating, for each input content in the validation set, the cosine similarity to all samples in the training set respectively, and then random sampling only from a preset percentage of the training set samples, for example, random sampling from 50% of the training set samples to form an input; and
converting the prompts input to xₚᵣₒₘₚₜ=T(xᵢₙ)

However, step S102 can be performed in two parts:

The first part, firstly determining the candidate tag word set, which may include the following steps;
the first step, initializing the vocabulary V;
the second step, vectorizing all the words in the vocabulary using a word2vec method, and determining a near-synonym set S^{c} corresponding to each tag via the cosine similarity;
the third step, selecting, for each category c in the training set, a Topk word set V^{c} in the vocabulary that maximizes the conditional probability by a pre-training model [symbol] that is not fine-tuned;

$${Topk}_{v ∈ V} \{ {\sum }_{{x}_{in} ∈ {D}_{train}^{c}} log {P}_{ℒ} ( [ MASK ] = v \vert T ( {x}_{in} ) ) \}$$

where P [symbol] represents a model [symbol] -based output probability distribution;
the fourth step, determining the candidate tag word under each category to be the maximum Topn of the intersection of the near-synonym set and the conditional probability set, namely M^{c}=Topn{S^{c}∩V^{c}} where n<k; and
the fifth step, integrating candidate tag words under various categories, and then finding the assignment mode that maximizes the accuracy rate of the training set as the temporary optimal candidate tag word.

The second part: determining a candidate prompt template set, which can include: first determining an optimal candidate tag word; generating an initial prompt template by filling a placeholder, wherein the prompt template is used to maximize the output probability in the training set; and finally, decoding the initial prompt template by using the cluster search algorithm to obtain the candidate prompt template. Since the generation-oriented natural language model is pre-trained based on multiple unsupervised goals, it is suitable to generate the prompt template by filling placeholders <X> and <Y>.

The acquired first n candidate tag word sets for each category above are denoted as {M¹, M², . . . , M^{c}, . . . , M^{N}}, where M^{c} represents the candidate tag word set mapped when the category is c, and N represents the quantity of categories. The candidate template set T obtained above is combined. The two are combined into a search space such as the search space list of Table 1 to find the optimal way to assign tag words and templates in the fine-tuning process, which is represented by the list L of (1*N+1), where the coded number in L[0: N−1] represents the subscript of the candidate tag word in the corresponding set, and the coded number in L[N] represent the subscript of the candidate template in the corresponding set.

TABLE 1
Search space list

| Candidate set | M¹ | M² | M^{c} | M^{N} | [symbol] |
|---|---|---|---|---|---|
| Code No. | 0/1/ . . . /n − 1 | 0/1/ . . . /n − 1 | 0/1/ . . . /n − 1 | 0/1/ . . . /n − 1 | 0/1/ . . . /p − 1 |

However, the meanings of the key factors in the reinforcement learning in the disclosure can refer to Table 2, which is a comparison table of reinforcement learning and the meanings thereof, and includes the objects and meanings of reinforcement learning applied in the embodiment:

TABLE 2
Comparison table of objects and meanings of reinforcement learning

| Reinforcement learning | Meaning |
|---|---|
| Agent | Policy Network (RNN Controller) |
| Environment | Language model environment |
| Action | Tag word and template selection (coding) |
| State | Current tag word and prompt template |
| Reward | Accuracy |

Then the text is input into a model that includes the language model environment to obtain the output result. The output result is compared with the tag, and the loss of the two is calculated. The loss result is fed back as a reward to the agent, and the agent determines the selection directions of the template and the tag word according to the reward until the optimal tag word and the prompt template can be determined.

In the embodiment of the disclosure, by constructing a candidate tag word set and selecting an intersection of a near-synonym set and a conditional probability set, the candidate tag word search space can be reduced, and at the same time, the difference between different prompt templates can be reduced, improving the accuracy of a downstream task. In addition, the use of the prompt fine-tuning pre-training model can reduce memory requirements and system complexity, especially to prevent small sample over-fitting. The candidate tag words under each category are regarded as the intersection of the near-synonym set and the conditional probability set, which reduces the search space of tag words. At the same time, the disclosure uses a reinforcement learning process to search for the optimal tag words and templates, so as to solve the problem that a general algorithm easily falls into a local optimum.

In the following, the embodiment of the disclosure illustrates an application process of the disclosure by taking a pre-trained GPT-3 model as an example:

The embodiment of the disclosure adopts the Chinese natural language understanding data set from the CLUE Benchmark (Chinese Language Understanding Evaluation Benchmark), which includes multiple different types of tasks, including sentiment analysis tasks, natural language reasoning, multiple text classifications, text matching tasks, and idiom reading comprehension. The following is an example of an E-commerce product review sentiment analysis data set (EPRSTMT).
Data volume: training set (32), verification set (32), test set (753)
Examples: {“id”: 23, “sentence”: “There is some wear and tear on the outer packaging, and it feels good after listening to it”, “label”: “Positive”}

Each piece of data has three attributes, id, sentence, and label from front to back. The label is a tag. Negative means negative, corresponding to 0. Positive means positive, corresponding to 1.

First step: raw training and verification data is converted to prompts input and true_labels list. For example, sentence: “there is some wear and tear on the outer packaging, and it feels good after listening to it” is an example of the validation set, similar samples s1: “received, listened, sound quality allowed” and s2: “low microphone sound, the phone can play even the earphone is plugged, inferior, don't buy” are found in the training set using the SBERT method. Using the initialization template format and tag words, the example of the final prompts is as follows:

s1. This evaluation is very positive. s2. This evaluation is very negative. sentence. This evaluation is very [MASK]

Note that GPT-3 does not consider the delimiter such as [CLS][SEP] when pre-training the input, so the corresponding downstream task input is not added.

Second step: candidate tag words are automatically selected.

Assuming that the result as a negative candidate set M¹ is {terrible, bad, negative}, and the positive candidate set M² is {great, good, positive}.

Step 3: candidate templates are automatically selected.

Assume candidate template T: {sentence. this evaluation is very [MASK].

sentence. the consumer attitude is very [MASK].

sentence. one evaluation of [MASK].}

Step 4: the optimal tag words and prompt template are searched by reinforcement learning

| Candidate set | M¹ | M² | [symbol] |
|---|---|---|---|
| Code No. | 0/1/2 | 0/1/2 | 0/1/2 |

Note that the more task categories and candidates there are, the more obvious the advantages of reinforcement learning are.

Assuming that the tag words are searched: {difficult to use, not bad}, find the template: this evaluation is very [MASK], then the corresponding textless input is:

N/A. This evaluation is very difficult to use.

N/A. This evaluation is very not bad.

This evaluation is very difficult to use.

This evaluation is very not bad.

[MASK]. This evaluation is very difficult to use.

[MASK]. This evaluation is very not bad.

Assuming that the input into the pre-training model is textless, the output tag word corresponding probability is averaged and normalized to obtain p_cf: [0.03201457 0.96798543], it can be seen that the current model has a very obvious preference for positive tag words; the correction matrix W can be calculated according to the formula [diag(p_cf)]⁻¹:

[[31.23577589 0.]

[0. 1.0330734]]

Assuming that input sample: “Surprisingly, one of the earphones is broken, and I'm too lazy to replace it.” The forming template format is input into the LM model to output tag words {poor, good} corresponding to probabilities [0.000906262, 0.01283005], normalized [0.06597569 0.93402431], and predicted as “good” based on the maximum value position, resulting in a wrong prediction. In practical application, it is [2.06080189, 0.96491567] after correction calculation based on W*pₚᵣₑ and it is predicted as “poor” based on the maximum value position, resulting in a correct prediction.

In the embodiment of the disclosure, a policy network can be updated with the corrected accuracy as reward feedback, thereby outputting better tag words and template selections.

It should be noted that the present embodiment is described on the basis of sentiment classification, but in practice is not limited to classification, and other downstream tasks such as gestalt filling, natural language inference, etc. can be improved in this way.

A small sample fine-tuning system provided by an embodiment of the disclosure is described below, and the small sample fine-tuning system described below and the small sample fine-tuning method described above can be referred to correspondingly.

FIG. 2 is a structural schematic diagram of a small sample fine-tuning method provided in an embodiment of the disclosure, and the disclosure also provides a small sample fine-tuning system, including:
a sample forming module configured to input a data set and form an input sample according to a fixed template;
a candidate set construction module configured to construct a candidate tag word set and a candidate prompt template set;
optimum selecting module configured to search, by means of reinforcement learning, an optimal tag word corresponding to the input sample from the candidate tag word set, and a prompt template corresponding to the input sample from the candidate prompt template set; and
an output module configured to output a mapping relationship of the optimal tag word and an optimal prompt template format corresponding to the prompt template.

Based on the above examples, as some embodiments, the sample forming module includes:
an input unit configured to acquire input content;
a conversion unit configured to represent the input content in the fixed template;
a similarity calculation unit configured to calculate the cosine similarity between the input content and all samples in the training set; and
a sampling unit configured to randomly sample from a preset percentage of training set samples to obtain the input sample.

The disclosure also provides a non-volatile readable storage medium having stored thereon a computer program that, when executed by a computer, enables the implementation of the steps provided in the above embodiments. The storage medium can include various media that can store the program code, such as U-disk, removable hard disk, ROM (Read-Only Memory), RAM (Random Access Memory), and magnetic or optical disk.

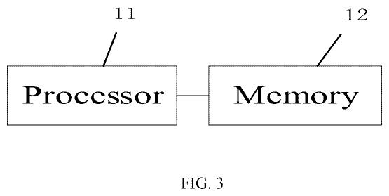

With reference to FIG. 3, the disclosure also provides an electronic device 11, which may include a memory having stored thereon a computer program, and a processor 12 that implements the steps of the method provided in the above-mentioned embodiments when calling the computer program in the memory 11. Of course, the electronic device may also include various components such as a network interface, a power supply, etc.

Various embodiments are described in the description in a progressive manner. Each embodiment focuses on the differences from other embodiments, and the same and similar parts between the various embodiments can be referred to each other. For the system provided in the embodiments, due to its correspondence with the methods provided in the embodiments, the description is relatively simple. Please refer to the method section for relevant information.

The disclosure applies examples to explain the principles and implementation methods of the disclosure. The above examples are only used to help understand the methods and core ideas of the disclosure. It should be pointed out that for ordinary technical personnel in this field, several improvements and modifications can be made to the disclosure without departing from the principles of the disclosure, and these improvements and modifications also fall within the scope of the claims in the disclosure.

It should be noted that relational terms herein such as “first” and “second”, and the like, are used solely to distinguish one entity or operation from another entity or operation without necessarily requiring or implying any actual such relationship or order between such entities or operations. Further, the terms “include”, “comprise”, or any other variation thereof are intended to cover nonexclusive inclusion, so that a process, method, item, or device that includes a series of elements not only includes those elements, but also other elements that are not explicitly listed, or also include elements inherent in such a process, method, item, or device. An element proceeded by the sentence “comprises . . . ” does not, without more constraints, preclude the existence of additional identical elements in the process, method, article, or device that comprises the element.

1. A small sample fine-tuning method, comprising:
inputting a data set, and forming an input sample according to a fixed template;
constructing a candidate tag word set and a candidate prompt template set;
by means of reinforcement learning, searching an optimal tag word corresponding to the input sample from the candidate tag word set, and a prompt template corresponding to the input sample from the candidate prompt template set; and
outputting a mapping relationship of the optimal tag word and an optimal prompt template format corresponding to the prompt template

2. The small sample fine-tuning method according to claim 1, further comprising:
dividing the data set into a training set, a validation set, and a test set; wherein
the training set is configured to random sample to form the input sample; and
the validation set is configured to calculate a cosine similarity.

3. The small sample fine-tuning method according to claim, further comprising:
forming the data in the data set according to ID attributes, sentence attributes, and label attributes, wherein, the ID attributes are configured to represent IDs of the data, the sentence attributes are configured to represent contents of the data, and the label attributes are configured to represent tag words of the data.

4. The small sample fine-tuning method according to claim 1, wherein the step of inputting the data set, and forming the input sample according to the fixed template comprises:
acquiring input content;
representing the input content in the fixed template;
calculating a cosine similarity between the input content and all samples in a training set; and
random sampling from a preset percentage of training set samples to obtain the input sample.

5. The small sample fine-tuning method according to claim 4, further comprising:
initializing a prompt template format;
representing the input content in the initialized prompt template format.

6. The small sample fine-tuning method according to claim 4, wherein the step of calculating the cosine similarity between the input content and all samples in the training set comprises:
encoding the input content using the SBERT method; and
calculating, for each input content in a validation set, the cosine similarity to all samples in the training set respectively.

7. The small sample fine-tuning method according to claim 3, further comprising:
converting the input sample to a prompts input.

8. The small sample fine-tuning method according to claim 1, wherein the constructing the candidate tag word set and the candidate prompt template set comprises:
automatically selecting the optimal candidate tag word; and
automatically selecting a candidate prompt template.

9. The small sample fine-tuning method according to claim 8, wherein the automatically selecting the candidate tag word comprises:
initializing a vocabulary;
vectorizing all the words in the vocabulary using a word2vec method, and determining a near-synonym set corresponding to each tag via the cosine similarity;
selecting, for each category in the training set, a word in the vocabulary that maximizes the conditional probability, and a conditional probability set comprising the word, by a pre-training model that is not fine-tuned:
determining a candidate tag word under each category as a maximum value of a geometric intersection of the near-synonym set and the conditional probability; and
integrating candidate tag words under various categories, and determining an assignment mode which maximizes the accuracy rate of the training set as the optimal candidate tag word.

10. The small sample fine-tuning method according to claim 9, further comprising:
determining the conditional probability set through the formula:
$${Topk}_{v ∈ V} \{ {\sum }_{{x}_{in} ∈ {D}_{train}^{c}} log {P}_{ℒ} ( [ MASK ] = v \vert T ( {x}_{in} ) ) \} ;$$
wherein Topk is a word with the maximum conditional probability; V is an initialization vocabulary; [symbol] is a pre-trained model that is not fine-tuned; c is each category in the training set; P [symbol] represents the output probability distribution based on the model [symbol] ; and T(Xᵢₙ) is an input sample.

11. The small sample fine-tuning method according to claim 9, wherein the automatically selecting the candidate prompt template comprises:
determining the optimal candidate tag word;
generating an initial prompt template by filling a placeholder; wherein the initial prompt template is configured to maximize an output probability in the training set; and
decoding the initial prompt template using a bundle search algorithm to obtain the candidate prompt template.

12. The small sample fine-tuning method according to claim 11, wherein by means of reinforcement learning, searching the optimal tag word corresponding to the input sample from the candidate tag word set, and the prompt template corresponding to the input sample from the candidate prompt template set comprises:
determining a preset number of candidate tag word set for each category;
combining the candidate tag word set with a template set corresponding to the candidate prompt template to obtain a search space list;
by means of the search space list, determining an optimal tag word corresponding to the input sample from the candidate tag word set, and a prompt template corresponding to the input sample from the candidate prompt template set.

13. The small sample fine-tuning method according to claim 12, further comprising:
by combining the candidate tag word set with a template set corresponding to the candidate prompt template, obtaining the search space list, to determine the optimal assignment mode of the candidate tag word and the candidate prompt template in the fine-tuning process.

14. The small sample fine-tuning method according to claim 1, further comprising:
determining the optimal tag word and the prompt template by key factors in reinforcement learning, wherein the key factors comprise agent, environment, action, status, and reward.

15. The small sample fine-tuning method according to claim 14, wherein the step of determining the optimal tag word and the optimal prompt template format comprises:
inputting the text into the model to obtain an output result; the model comprising a language model environment;
calculating a loss of the output result and the tag word;
feeding back the loss as the reward to the agent; and
determining, by the agent, selection directions of the template and the tag word according to the reward until the optimal tag word and the prompt template are determined.

16. The small sample fine-tuning method according to claim 1, further comprising:
when the input is textless, averaging the output tag word corresponding probability and then normalizing to obtain a normalized probability p_cf; and calculating a correction matrix according to the formula [diag(p_cf)]⁻¹.

17-18. (canceled)

19. A non-volatile readable storage medium having stored thereon a computer program that, when executed by a processor, implements the steps of the method according to claim 1.

20. An electronic device, comprising a memory having stored thereon a computer program, and a processor that implements the steps of the method according to claim 1 when calling the computer program in the memory.

21. The electronic device according to claim 20, wherein the constructing the candidate tag word set and the candidate prompt template set comprises:
automatically selecting the optimal candidate tag word; and
automatically selecting a candidate prompt template.

22. The electronic device according to claim 21, wherein the automatically selecting the candidate tag word comprises:
initializing a vocabulary;
vectorizing all the words in the vocabulary using a word2vec method, and determining a near-synonym set corresponding to each tag via the cosine similarity;
selecting, for each category in the training set, a word in the vocabulary that maximizes the conditional probability, and a conditional probability set comprising the word, by a pre-training model that is not fine-tuned:
determining a candidate tag word under each category as a maximum value of a geometric intersection of the near-synonym set and the conditional probability; and
integrating candidate tag words under various categories, and determining an assignment mode which maximizes the accuracy rate of the training set as the optimal candidate tag word.
